(19) United States
(12) Patent Application Publication
(10) Pub. No.: US 2026/0175898 A1
(43) Pub. Date: Jun. 25, 2026

(54) STEERING WHEEL WITH METAL ALLOY RIM AND ATTACHMENT INSERT

(71) Applicant: AUTOLIV DEVELOPMENT AB, Vargarda (SE)

(72) Inventor: Mickael PEYROT, Latillé (FR)

(21) Appl. No.: 19/132,690

(22) PCT Filed: Nov. 23, 2023
(86) PCT No.: PCT/EP2023/082801

§ 371 Date: May 23, 2025

(30) Foreign Application Priority Data
Nov. 25, 2022 (FR) FR2212339

(51) Int. Cl. B62D 1/08; B62D 1/06; B62D 1/10

(52) U.S. Cl. CPC B62D 1/08; B62D 1/06; B62D 1/10

(57) ABSTRACT

A vehicle steering wheel, comprising a hub connected to a steering device of vehicle, at least one rim portion arranged to be gripped by a driver to steer the vehicle and comprising a metal frame, at least one attached branch connecting the hub to said at least one rim portion, wherein the metal frame comprises a body made of metal alloy such as magnesium, at least one attachment insert at least partially embedded in the body and comprising an interface for attaching said at least one branch to said at least one rim portion and wherein the steering wheel comprises at least one element for attaching said at least one branch to said at least one rim portion.

### TECHNICAL FIELD OF THE INVENTION

The present invention relates generally to vehicle steering wheels and vehicles, in particular motor vehicles.

### PRIOR ART

Vehicle steering wheels are known in the prior art, in particular comprising a rim with a metal frame incorporating a magnesium alloy. On the other hand, this system can exhibit manufacturing and service life difficulties, particularly when it comes to attaching a branch to the rim, due to the mechanical characteristics of the magnesium alloy. Reference is also made to document JP2022011766.

### DISCLOSURE OF THE INVENTION

One aim of the present invention is to overcome the above-mentioned disadvantages of the prior art and, in particular, firstly, to provide a steering wheel that enables an attached branch to be assembled easily and with improved service life, with a rim portion comprising a metal frame having a body made, for example, of a magnesium alloy.

For this, a first aspect of the invention therefore relates to a vehicle steering wheel, comprising:
a hub, arranged to be connected to a steering device of the vehicle,
at least one rim portion, arranged to be gripped by a driver to steer the vehicle and comprising a metal frame,
at least one attached branch, connecting the hub to said at least one rim portion, characterized:
   in that the metal frame comprises:
a body made of metal alloy such as magnesium,
at least one attachment insert, preferably made of steel, at least partially embedded in the body or overmolded by the body, and comprising an interface for fastening said at least one branch to said at least one rim portion, and in that the steering wheel comprises at least one attachment element arranged to attach said at least one branch to said at least one rim portion in combination with said at least one attachment insert.

In this way, the attachment insert is inserted or attached to the body during its manufacture, typically during injection molding or casting, so that it becomes one with the body. The attachment of an element (typically said at least one attached branch) to the frame at the attachment insert is thus strengthened, since the attachment insert enables the connection to be strengthened in a localized and compact manner. This makes it possible to offer a steering wheel with a rim portion incorporating a metal alloy (e.g. magnesium) assembled with an attached branch, while facilitating manufacture and improving durability and service life. It's worth noting that metal alloys (e.g. magnesium) are generally considered brittle, making it difficult or adventurous to attach the branch directly (brittle or flimsy connection, mechanical play, etc.), and that the use of an attachment insert considerably improves manufacturing and service life. It should also be noted that the partial embedding of the attachment insert protects the insert, prevents the attachment interface from protruding beyond the rim, particularly on the outer side of the rim, and/or hinders the driver by creating an unattractive protrusion. In addition, this improves the attachment of the attached branch to the rim portion, resulting in a strong connection free of mechanical play.

A second aspect of the invention relates to a vehicle steering wheel comprising:
a hub arranged to be connected to a steering device of the vehicle,
at least one rim portion, arranged to be gripped by a driver to steer the vehicle and comprising a metal frame,
at least one attached branch, connecting the hub to said at least one rim portion, characterized:
   in that the metal frame comprises:
a body made of metal alloy such as magnesium,
at least one attachment collar, preferably made of steel, at least partially wound and/or crimped around the body, and comprising an interface for fastening said at least one branch to said at least one rim portion, and in that the steering wheel comprises at least one attachment element arranged to attach said at least one branch to said at least one rim portion in combination with said at least one attachment collar.

This makes it possible to offer a steering wheel with a rim portion incorporating a metal alloy (e.g. magnesium) assembled with an attached branch, while facilitating manufacture and improving durability and service life. It should be noted that the metal alloy (e.g. magnesium) is brittle, making it difficult to attach the branch directly, and the use of an attachment collar considerably improves manufacturing and service life. It is further noted that the partial winding or crimping of the attachment collar helps to protect the rim, particularly at the attachment interface, to prevent the attachment from damaging the metal alloy (e.g. magnesium) body, which is brittle if the attachment element is attached directly to it. In addition, this improves the attachment of the attached branch to the rim portion, resulting in a strong connection free of mechanical play.

The following advantageous features relate to the two aspects mentioned above.

Advantageously, the attachment interface is a screw attachment interface, and the attachment element is a screw attachment element.

This makes it possible to offer a robust and removable way of attaching the branch to the rim, while avoiding the need to attach the branch directly to the metal alloy (e.g. magnesium) body, wherein it is not desirable to provide a thread, notably for reasons of fragility and complexity of construction. An example of a screw attachment interface is a threaded hole. An example of a screw attachment is a screw or stud.

Advantageously, the attachment interface is a riveting attachment interface, and the attachment element is a riveting attachment element.

This makes it possible to offer a robust way of attaching the branch to the rim, while avoiding the need to attach directly to the metal alloy (e.g. magnesium) body. An example of a rivet fastening is a rivet or pin. An example of a rivet attachment interface is a calibrated hole, arranged to receive a rivet or pin.

Advantageously, either the metal frame or branch comprises a locating index, and the other of the metal frame and branch comprises a locating cavity receiving the locating index.

Advantageously, either the metal frame or branch comprises two locating indexes, and said other of the metal frame and branch comprises two locating cavities each receiving one locating index.

Advantageously, the two locating indexes are separated by a distance of at least 20 mm, preferably at least 30 mm and most preferably at least 40 mm.

This enables the branch to be precisely located (or positioned) on the metal framework.

Advantageously, the attachment element is arranged on the attachment index.

Advantageously, the attachment insert comprises a locating index, and the branch comprises a locating cavity receiving the locating index.

Advantageously, the attachment insert comprises two locating indexes, and the branch comprises two locating cavities each receiving one locating index.

Advantageously, the two locating indexes are separated by a distance of at least 20 mm, preferably at least 30 mm and most preferably at least 40 mm.

This enables the branch to be precisely located (or positioned) on the insert.

Advantageously, the attachment element is arranged on the attachment index.

Advantageously, the attachment element passes at least partially through the locating cavity.

Advantageously, the body of said at least one rim portion forms a continuous hoop, extending 360° around.

Advantageously, the vehicle steering wheel comprises two attached branches.

Advantageously, the vehicle steering wheel comprises a covering, preferably partly overmolded, above said at least one rim portion and/or said at least one branch.

Advantageously, the rim covering reveals a metal frame reference portion arranged to receive a portion of the branch. This makes it easier to locate the branch relative to the rim, since part of the branch can rest directly on the metal frame.

Advantageously, the covering comprises a passage opening or passage space arranged opposite the attachment interface, the opening or passage space being designed to provide a passage at least for the attachment element and/or part of the branch.

Advantageously, the passage opening is arranged to allow access to the frame reference portion.

Advantageously, the covering comprises:
a rim covering that at least partially covers said at least one rim portion
a branch covering that at least partially covers said at least one branch, and wherein the rim covering and the branch covering are separate and/or independent.

In other words, the rim covering, typically a foam covering with or without an outer sheath, is applied to the rim alone, before assembling said at least one branch. This eliminates the need to place the entire steering wheel in the foaming mold and/or to reject a complete steering wheel in the event of improper foaming.

Advantageously, the passage opening or passage space is provided in the rim covering, and/or wherein the branch covering comprises a covering insert arranged to cover at least part of the passage opening or passage space.

Advantageously, the passage opening or space is formed in an attached foam, arranged glued or inserted in or on a main foam overmolded on the metal frame. This makes it possible to define a simpler mold for the main foaming process, and therefore a lower cost.

Advantageously, the rim covering comprises a decorative part, such as a cap, covering at least part of the rim covering, such as for example a sheath attached to the said at least one rim portion prior to assembly of the said at least one rim portion on said at least one branch.

Advantageously, the attachment element provides an embedded-type connection of said at least one rim portion to said at least one branch. This provides a robust connection between the rim and the branch.

Advantageously, the vehicle steering wheel comprises a joint, preferably of the pivot type, between said at least one branch and the hub.

Advantageously, the positioning index is provided on the attachment insert.

Advantageously, the positioning index is provided on the attachment collar.

Advantageously, the rim covering comprises an inner covering material, for example overmolded, such as polyurethane, and an outer covering material, such as a sheath, leather sheath or synthetic sheath,
the branch covering comprises at least one decorative piece forming a shell or part of a shell around said at least one branch.

A third aspect concerns a motor vehicle comprising a vehicle steering wheel according to one of the first aspect and/or the second aspect, with the above-mentioned advantages.

### DESCRIPTION OF THE FIGURES

Other features and advantages of the present invention will become more apparent upon reading the following detailed description of an embodiment of the invention, which is provided by way of example but in no manner limited thereto, and shown by the attached drawings, wherein:

FIG. 1 shows a front view of a steering wheel according to the present invention, in a first embodiment,

FIG. 2 shows a detail view of the steering wheel, at an interface for attaching a branch to a rim portion,

FIG. 3 shows a cross-sectional view of the steering wheel along A-A, showing an attachment insert and a rim frame,

FIG. 4 shows a view of the attachment insert overmolded on the rim frame,

FIG. 5 shows a view of the attachment insert,

FIG. 6 shows a complete cross-sectional view of the steering wheel along A-A, showing the attachment insert and rim frame,

FIG. 7 shows a schematic cross-sectional view of the steering wheel, according to a second embodiment,

FIG. 8 shows a detailed side view of the steering wheel according to the second embodiment.

### DETAILED DESCRIPTION OF EMBODIMENT(S)

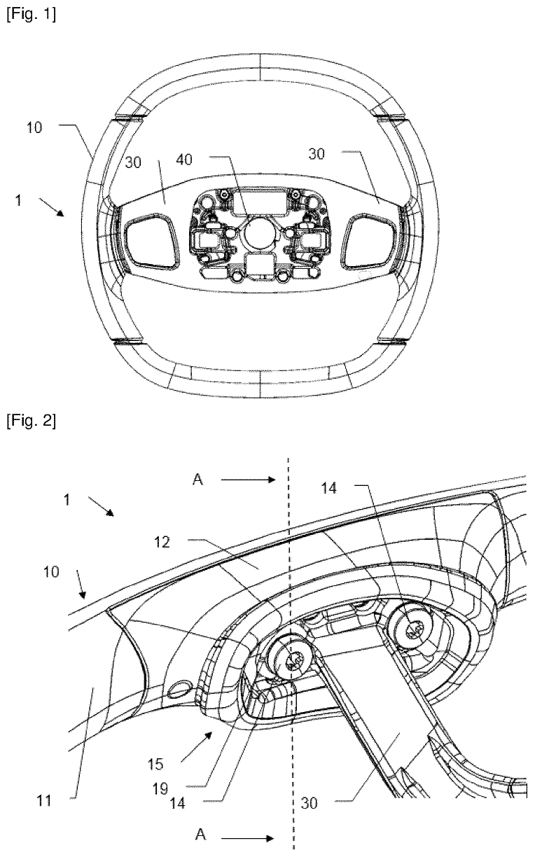

FIG. 1 shows a front view of a vehicle steering wheel 1 according to the present invention, in a first embodiment.

FIG. 1 shows the steering wheel 1 forming a steering device for a motor vehicle. According to the non-limiting example shown, the steering wheel 1 comprises a hub 40, at least one attached branch 30 (here two attached branches, the number of branches being non-limiting and may be less, for example one, or more than two, for example three, four, five, etc.), and a rim portion 10 connected to the hub 40 by the branches 30. The hub 40 is arranged to be connected to a vehicle steering device. The rim portion 10 is arranged to be gripped by a driver to steer the vehicle.

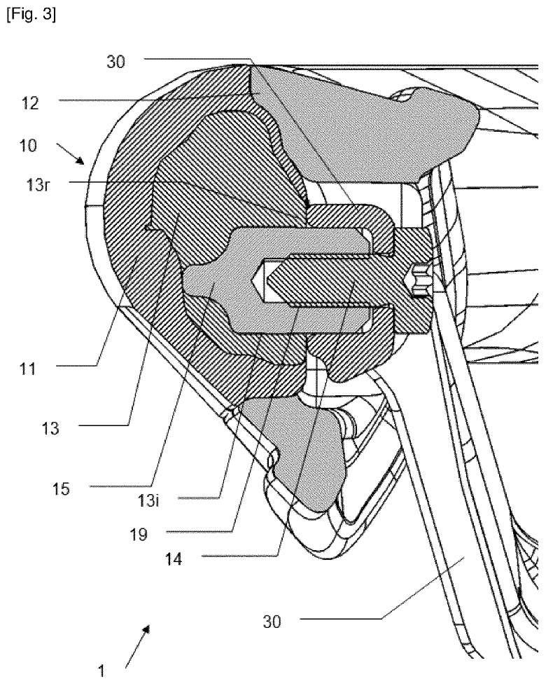

The rim portion 10 comprises an underlying vehicle steering wheel frame 13 shown in FIG. 3. Frame 13 refers to the carcass or framework designed to support the other components of the rim (typically the overmolding or foaming, covering parts, controls such as horn controls, buttons, etc.). Frame 13 is metal and typically comprises a metal alloy (e.g. magnesium) body and at least one attachment insert 15 visible in FIG. 3.

FIG. 2 shows a detail view of the steering wheel 1, at an attachment interface 19 between one of the rim inserts 30 and the rim portion 10.

The attachment insert 15 is at least partially embedded in the rim body 10 and comprises the interface 19 for attaching the branch 30 to the rim 10.

The steering wheel 1 comprises at least one element 14 for attaching the branch 30 to the rim 10. In the example shown in FIG. 2, there are two attachment elements 14 which are screw attachment elements (also known as screws): the two attachment elements 14 are screwed into threaded holes, which are examples of screw attachment interfaces 19.

The attachment insert 15 is preferably made of steel, to provide a suitable material for the fastening interfaces 19, in particular the threaded holes.

In other words, the branch 30 is thus attached to the rim 10 by screwing the screws 14 into the threaded holes 19 on the attachment insert 15.

The steering wheel 1 may comprise a main foam 11 and an attached foam 12. The main foam 11 is arranged to at least partially cover the frame 13 and the attached foam 12 is arranged to at least partially cover the attachment insert 15. The attached foam 12 covers gripping areas not covered by the main foam 11; the gripping areas (parts of the attachment insert 15) keep the frame 13 away from the walls of an injection mold for the main foam 11.

Finally, FIG. 2 shows the axis of cross-section A-A, for the cross-sectional view along A-A in FIG. 3.

FIG. 3 shows a cross-sectional view of the steering wheel 1 along A-A, showing the attachment insert 15 and the rim frame 13.

Also visible in FIG. 3 are the main foam 11 and attached foam 12, arranged as previously indicated.

The screw 14 is screwed into the threaded hole 19 to secure the branch 30 to the attachment insert 15 and thus ultimately to the rim 10 via the frame 13. It should be noted that, along one axis of the screw 14, the branch 30 is supported and pressed against a reference portion 13r of the metal frame 14, not against the attachment insert 15, to guarantee the rim's position with greater precision.

The insert 15, preferably made of steel, is at least partially embedded in the metal alloy (e.g. magnesium) body of the metal frame 13.

This allows the insert 15 to be at least partially concealed, while providing a change of material between the insert 15 and the metal frame 13 (typically magnesium alloy), to enable better attachment of the branch 30 to the rim 10.

The branch 30 may further comprise a locating cavity arranged to receive attachment element 14 (e.g. a calibrated hole for locating a shank (or external cylindrical surface) of the attachment element). In other words, screw 14 passes through branch 30 at the locating cavity.

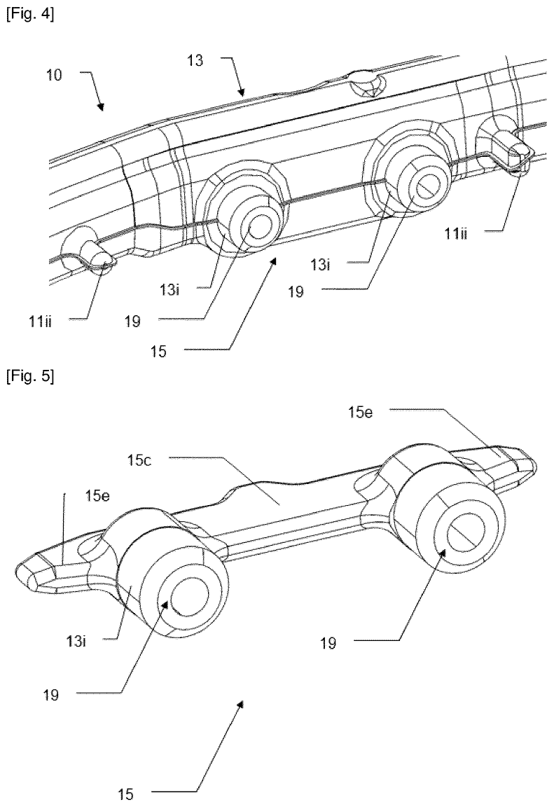

FIG. 4 shows a view of insert 15 overmolded by the rim 10 of the frame 13. Typically, the insert 15 can be produced in advance (e.g. by stamping, machining or sintering) before being placed in the injection mold of the frame 13. During injection molding, the material of frame 13 partially covers insert 15.

In the example shown in FIG. 4, insert 15 is shown with two fastening interfaces 19 (e.g. threaded holes for the screw attachment interface).

The frame 13 may further comprise two locating indexes 13i, for more precise positioning of the rim 10 and attached branch 30. The indexes 13i can also be positioned on the insert 15: in this case, the indexes 13i are, for example, the outsides of the screwing shanks 19. The main foam 11 is provided with pins 11ii arranged to position the attached foam (or secondary foam pad) 12.

FIG. 5 shows a view of insert 15 with the two fastening interfaces 19.

In addition, the insert 15 may comprise a main body 15c between attachment interfaces 19 and two distal ends 15e. Each attachment interface 19 is arranged between the main body 15c and a distal end 15e. This facilitates partial embedding of the insert 15 in the body of the metal frame 13, and improves attachment of the attached branch 30 to the rim 10.

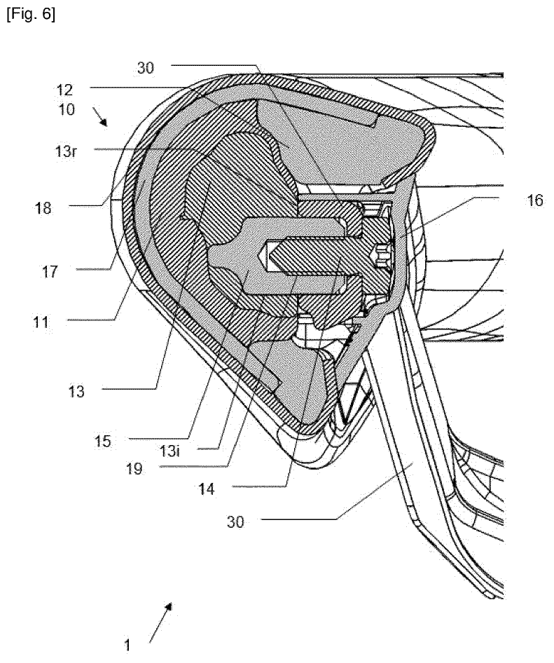

FIG. 6 shows a complete cross-sectional view of the steering wheel along A-A, showing the attachment insert 15 and rim frame 13.

FIG. 6 further shows the steering wheel 1 with a sheath 18, preferably made of leather or synthetic material, covering a sheathed element 17 (typically a capacitive sensor, a heating grid or a piece of finishing foam), itself covering the main foam 11. In other words, the sheath 18 and the sheathed foam are examples of (rim) coverings. It is also possible to provide a branch covering in a similar way. As shown in FIG. 6, the sheath 18 does not cover the attachment areas. In this way, the sheath 18 can be placed on the rim 10 before the latter is assembled to the branch 30. The sheath 18 is designed with an opening or with two ends that do not meet to allow the attachment element 14 (and a cap 16) to pass through.

The steering wheel 1 may further comprise the cap 16 concealing the insert 15, the attachment interface 19 and/or the attachment element 14. In other words, the cap 16 is an example of a covering insert fitted to conceal the connection between the 30 branch and the 10 rim.

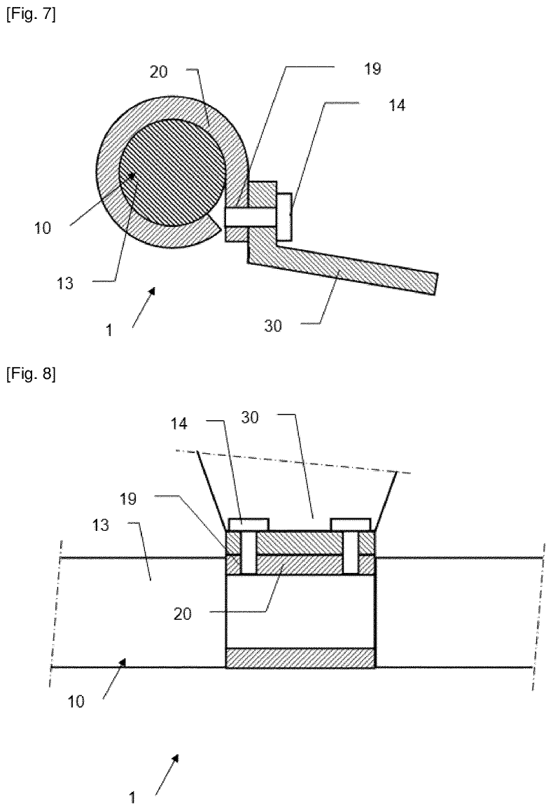

FIG. 7 shows a schematic cross-sectional view of the steering wheel 1, according to a second embodiment.

The steering wheel 1 comprises the rim portion 10 with the metal frame 13 and the at least one branch 30. An attachment collar 20, preferably made of steel, is used to secure the branch 30 to the rim 10, by means of at least one attachment element 14 (e.g. a screw 14, rivet or pin) and at least one corresponding attachment interface 19.

FIG. 8 shows a detailed side view of the steering wheel 1 according to the second embodiment.

Thus, the attachment collar 20 is visible. It is wound and/or crimped around the body of the metal frame 13, and is used to secure or attach the branch 30 to the rim 10.

The embodiments and their variants can be combined to the extent possible and/or necessary.

### INDUSTRIAL APPLICATION

A steering wheel 1 according to the present invention, and its manufacture, are capable of industrial application.

It will be understood that various modifications and/or improvements which are obvious to the person skilled in the art may be made to the different embodiments of the invention described in the present description without departing from the scope of the invention. In particular, it may be noted that it is possible to provide other attachment elements 14 than screws or rivets. It is possible to adapt the engagement length of the fastening collar 20 to the body of the frame 13.

1-15. (canceled)

16. A vehicle steering wheel, comprising:
a hub, arranged to be connected to a steering device of a vehicle;
at least one rim portion, arranged to be gripped by a driver to steer the vehicle and comprising a metal frame; and
at least one attached branch, connecting the hub to said at least one rim portion,
wherein the metal frame comprises:
a body made of metal alloy such as magnesium; and
at least one attachment insert, preferably made of steel, at least partially embedded in the body or overmolded by the body, and comprising an interface for fastening said at least one branch to said at least one rim portion,
wherein the steering wheel comprises at least one attachment element arranged to attach said at least one branch to said at least one rim portion in combination with said at least one attachment insert.

17. A vehicle steering wheel, comprising:
a hub, arranged to be connected to a steering device of a vehicle;
at least one rim portion, arranged to be gripped by a driver to steer the vehicle and comprising a metal frame; and
at least one attached branch, connecting the hub to said at least one rim portion,
wherein the metal frame comprises:
a body made of metal alloy such as magnesium; and
at least one attachment collar, preferably made of steel, at least partially wound and/or crimped around the body, and comprising an interface for fastening said at least one branch to said at least one rim portion,
wherein the steering wheel comprises at least one attachment element arranged to attach said at least one branch to said at least one rim portion in combination with said at least one attachment collar.

18. The vehicle steering wheel according to claim 16, wherein the attachment interface is a screw attachment interface, and wherein the attachment element is a screw attachment element.

19. The vehicle steering wheel according to claim 16, wherein the attachment interface is a riveting attachment interface, and wherein the attachment element is a riveting attachment element.

20. The vehicle steering wheel according to claim 16, wherein either the metal frame or the branch comprises a locating index, and the other of the metal frame and the branch comprises a locating cavity receiving the locating index.

21. The vehicle steering wheel according to claim 20, wherein said one of the metal frame and the branch comprises two locating indexes, and said other of the metal frame and the branch comprises two locating cavities each receiving one locating index.

22. The vehicle steering wheel according to claim 21, wherein the two locating indexes are separated by a distance of at least 20 mm, preferably at least 30 mm and preferably at least 40 mm.

23. The vehicle steering wheel according to claim 20, wherein the attachment element is arranged onto the attachment index.

24. The vehicle steering wheel according to claim 20, wherein the attachment element passes at least partially through the locating cavity.

25. The vehicle steering wheel according to claim 16, comprising a covering, preferably partly overmolded, above said at least one rim portion and/or said at least one branch.

26. The vehicle steering wheel according to claim 25, wherein the covering comprises a passage opening or passage space arranged opposite the attachment interface, the opening or passage space being provided to provide a passage at least for the attachment element.

27. The vehicle steering wheel according to claim 26, wherein the covering comprises:
a rim covering that at least partially covers said at least one rim portion; and
a branch covering that at least partially covers said at least one branch,
wherein the rim covering and the branch covering are separate and/or independent.

28. The vehicle steering wheel according to claim 27, wherein the passage opening or passage space is provided in the rim covering, and/or wherein the branch covering comprises an attached covering part arranged to cover at least part of the passage opening or passage space.

29. The vehicle steering wheel according to claim 27, wherein the branch covering comprises a decorative part, such as a cap, covering at least part of the rim covering, such as for example a sheath attached to said at least one rim portion prior to assembly of said at least one rim portion to said at least one branch.

30. The vehicle steering wheel according to claim 16, wherein the attachment element provides an embedded-type connection of said at least one rim portion to said at least one branch.
